(19) United States
(12) Patent Application Publication
(10) Pub. No.: US 2007/0109720 A1
(43) Pub. Date: May 17, 2007

(54) DIELECTRIC PASTE, CAPACITOR-EMBEDDED GLASS-CERAMIC MULTILAYER SUBSTRATE, ELECTRONIC COMPONENT AND METHOD OF MANUFACTURING CAPACITOR-EMBEDDED GLASS-CERAMIC MULTILAYER SUBSTRATE

(75) Inventor: Takafumi Kamei, Kagoshima (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Kyocera Corporation, Kyoto (JP)

(21) Appl. No.: 11/553,208

(22) Filed: Oct. 26, 2006

(30) Foreign Application Priority Data
Oct. 27, 2005 (JP) 2005-312903

(51) Int. Cl. H01G 4/06

(52) U.S. Cl. 361/321.2

(57) ABSTRACT

A dielectric paste, and a dielectric layer of a capacitor-embedded glass-ceramic multilayer substrate comprise a barium titanate powder and a glass powder made of a glass containing manganese and a rare earth element and having a softening point of not higher than 1000° C. A method of manufacturing the capacitor-embedded glass-ceramic multilayer substrate comprise the steps of preparing a glass-ceramic green sheet, forming a capacitor area including electrode layers and a dielectric layer made of the dielectric paste; fabricating a laminated body by stacking the glass-ceramic green sheets; and sintering the laminate.

### CROSS-REFERENCE TO RELATED APPLICATIONS

The present application claims priority under 35 U.S.C. §119 to Japanese Patent Application No. 2005-312903, filed Oct. 27, 2005, entitled “DIELECTRIC PASTE, CAPACITOR-EMBEDDED GLASS-CERAMIC MULTILAYER SUBSTRATE AND METHOD OF MANUFACTURING CAPACITOR-EMBEDDED GLASS-CERAMIC MULTILAYER SUBSTRATE.” The contents of this application are embedded herein by reference in their entirety.

### BACKGROUND OF THE INVENTION

1. Field of the Invention

The present invention relates to a dielectric paste in which barium titanate is used, a capacitor-embedded glass-ceramic multilayer substrate in which barium titanate is used in a dielectric layer, and a method of manufacturing the capacitor-embedded glass-ceramic multilayer substrate.

2. Description of the Related Art

In order to miniaturize capacitors and accomplish large-capacitance designs, it is necessary to use dielectric materials having high dielectric constant. One of the dielectric materials capable of meeting the requirements for miniaturization and large-capacitance designs is oxide having the perovskite structure and having high dielectric constant, represented by barium titanate. Conventional glass-ceramic multilayer substrates in which capacitors are embedded are manufactured as described below. First, a dielectric paste containing a barium titanate powder as a main component and a conductor paste containing a low-resistance metal powder as a main component are printed on a glass-ceramic green sheet, whereby capacitors are formed. Next, the above-described conductor paste is printed on a glass-ceramic green sheet, whereby an interconnect layer is formed. And the glass-ceramic green sheets on which the capacitors are formed and the glass ceramic green sheets on which the interconnect layer is formed are stacked and a laminate is fabricated by co-firing the glass-ceramic green sheets at relatively low temperatures of not higher than 1000° C.

However, when the dielectric layer of a capacitor is formed of an oxide having the perovskite structure, oxygen vacancies are generated by applied voltage or heat. Therefore, the insulating properties of the embedded capacitor were deteriorated. When the layer was sintered in an atmosphere of low O₂ concentration, for example, an N₂ atmosphere, the dielectric constant decreased because barium titanate is reduced and oxygen vacancies are generated.

To solve the decreases in the insulating properties and the dielectric constant, the following method has been proposed. A ceramic capacitor is formed by sandwiching a dielectric substance, which contains barium titanate as a main component and to which manganese oxide (MnO) and a rare earth element are added, with a pair of internal electrodes using Ni. When this ceramic capacitor is sintered in an N₂ atmosphere, the manganese (Mn) and the rare earth element are replaced at the crystal lattice points of the perovskite structure, whereby it becomes possible to make the perovskite structure stable. As a result, even when a voltage is applied to the dielectric substance or even when the dielectric substance is heated, it is possible to suppress the decreases in the insulating properties and the dielectric constant.

However, when such method is applied to sintering of capacitor-embedded glass-ceramic substrate, it is necessary to sinter a dielectric substance containing barium titanate as a main component at 1250° C. to 1350° C. although a glass-ceramic substrate is sintered at temperatures of not higher than 1000° C. Therefore, when a glass-ceramic substrate in which a dielectric layer containing barium titanate as a main component and manganese and rare earth element as additives is embedded is sintered at temperatures of not higher than 1000° C., the dielectric layer is not sufficiently sintered and this poses the problem that the dielectric constant decreases, with the result that the insulating properties of the dielectric layer against heating and voltage application decrease.

### SUMMARY OF THE INVENTION

The present invention is to provide a dielectric paste which enables capacitors, which have high permittivity and in which a dielectric layer has high insulating properties against heating and voltage application, to be sintered at temperatures of not higher than 1000° C. The present invention also provides a glass-ceramic multilayer substrate which embeds capacitors having high dielectric constant and a dielectric layer having high insulating properties against heating and voltage application.

### BRIEF DESCRIPTION OF THE DRAWINGS

FIG. 1 is a sectional view which shows an example of an embodiment of a capacitor-embedded glass-ceramic multilayer substrate of the present invention;

FIG. 2 a sectional view which shows an example of an embodiment of an electronic component of the present invention;

FIG. 3 is a perspective view which shows an example of an embodiment of an electronic component of the present invention; and

FIGS. 4 through 6 are tables showing capacitance values and insulation resistance values of capacitors in Embodiments and Comparative Examples.

### DETAILED DESCRIPTION OF THE PREFERRED EMBODIMENTS

A detailed description will be given of a dielectric paste of the present invention, a glass-ceramic multilayer substrate in which a capacitor is embedded, an electronic component, a method of manufacturing the glass-ceramic multilayer substrate, and a method of manufacturing the electronic component by referring to preferred embodiments.

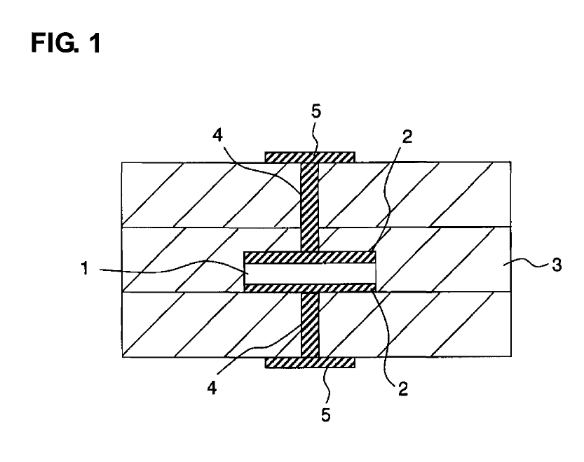

FIG. 1 is a sectional view which shows an example of an embodiment of a capacitor-embedded glass-ceramic multilayer substrate of the present invention.

In FIG. 1, the reference numeral 1 denotes a dielectric layer, the reference numeral 2 denotes an electrode layer, the reference numeral 3 denotes an insulating layer made of a glass ceramic, the reference numeral 4 denotes a through conductor, and the reference numeral 5 denotes an interconnect layer.

A dielectric paste contains 70.0 to 99.6 parts by mass of a barium titanate powder and 0.4 to 30.0 parts by mass of a glass powder. If this dielectric paste is used, the generation of voids in the interior of a dielectric layer 1 is suppressed when the dielectric layer 1 is sintered at temperatures of not higher than 1000° C. As a result, the dielectric layer 1 having high dielectric constant can be formed and, therefore, it is possible to apply this dielectric paste to the miniaturization and large-capacitance designs of a multilayer substrate in which capacitors are embedded.

If a dielectric paste of the present invention is used, even when oxygen vacancies are generated in a dielectric layer during sintering in an N₂ atmosphere or in the case of application of a voltage to the dielectric layer or heating of a sintered compact, manganese or a rare earth metal enters the generated oxygen vacancies. In other words, these elements replace the oxygen present at the lattice points of a perovskite crystal and, therefore, the perovskite crystal structure is stabilized and it is possible to maintain the dielectric layer having high dielectric constant and high insulating properties.

It is preferred that the barium titanate powder have a small grain size. For example, it is good if the 50% grain size in the cumulative grain size distribution of the number of grains obtained by measurements by use of the microtrack method and the like is not more than 0.7 μm. Because the grain size is small, it is easy to sinter the dielectric layer containing barium titanate as a main component at temperatures of not higher than 1000° C. Furthermore, it is easy to suppress the barium titanate powder from becoming porous due to the generation of voids and the like in the interior. As a result of these advantages, it becomes easy to obtain high dielectric constant and also it becomes easy to maintain the substrate strength at high levels.

It is important that the glass powder contain manganese and a rare earth metal. Because manganese and a rare earth metal are in the network of the glass, the manganese and the rare earth metal prevent sintering of the barium titanate from being inhibited. As a result, it is possible to perform sintering at temperatures of not higher than 1000° C., which is the softening point of the glass.

In addition, during the sintering, the manganese dissolves by replacement in Ti sites in a solid solution state in the perovskite structure of barium titanate, whereby the manganese acts as an acceptor. When sintering is performed in an atmosphere with a low O₂ concentration, for example, in an N₂ atmosphere, the barium titanate is reduced and oxygen vacancies appear. However, the manganese which is an acceptor dissolves by replacement in Ti sites in a solid solution state. Manganese has a valence which is by 2 smaller than titanium. Therefore, when manganese dissolves by replacement in Ti sites in a solid solution state, manganese electrically compensates for a barium titanate crystal which is charged +2 with appearance of an oxygen vacancy and hence it is possible to maintain the insulating properties of the crystal. As a result, it is possible to greatly improve the insulating properties and to increase chemical stability by a change in valence.

Furthermore, manganese has the effect of suppressing the grain growth of barium titanate in the sintering process and, therefore, it is possible to reduce the crystal grain size of barium titanate. As a result, the barium titanate which constitutes the dielectric layer can have a tetragonal crystal having high dielectric constant and a small change (a rate of temperature change) in dielectric constant in a wide temperature range and it is possible to increase the dielectric constant.

On the other hand, rare earth elements can dissolve in both of Ba sites and Ti sites when sintering is performed in an atmosphere with a low O₂ concentration, for example, in an N₂ atmosphere, and a rare earth element dissolved in the Ba sites or Ti sites behaves as an accepter or a donor. A rare earth element dissolves selectively in the Ba sites or Ti sites in the barium titanate which are generated during sintering, whichever is lacking. Therefore, as with manganese, it is possible to make the structure of barium titanate more stable by the compensation for electric charge. As a result, it is possible to greatly improve the insulating properties of the dielectric layer against heating and voltage application.

Rare earth elements mean Y and the actinoids of La to Lu. If a rare earth element has an ionic radius of a size intermediate between a Ba ion and a Ti ion, it is possible for the rare earth element to dissolve in both of Ba sites and Ti sites in a solid solution state. From the standpoint that the structure of barium titanate is formed from an electrochemically more stable crystal, examples of rare earth elements include Gd, Tb, Dy, Y, Ho, Er, Tm, Yb, Lu and the like.

The glass powder preferably contains manganese in amounts of 0.5 to 10.0 parts by mass for 100 parts by mass of the glass and the rare earth element in amounts of 2.0 to 25.0 parts by mass for 100 parts by mass of the glass. From the standpoint that the dielectric layer is more favorably sintered at temperatures of not higher than 1000° C. by relatively lowering the temperature at which the glass becomes a liquid phase, it is preferred that the amount of the manganese contained in the glass powder be not more than 10.0 parts by mass and that the amount of the rare earth metal contained in the glass powder be not more than 25.0 parts by mass. As a result of this, the dielectric layer is made denser by more effectively suppressing the generation of voids and the like in the interior of the dielectric layer, it becomes possible to obtain higher dielectric constant and at the same time, it becomes possible to further increase the substrate's mechanical strength. Also, from the standpoint that the reduction resistance of barium titanate is increased and the action of stabilizing the structure of barium titanate is increased, whereby a decrease in the insulating properties of the dielectric layer against heating and voltage application is more suppressed, it is preferred that the amount of the manganese contained in the glass powder be not less than 0.5 parts by mass and that the amount of the rare earth metal contained in the glass powder be not more than 2.0 parts by mass.

Incidentally, the component ratio of the manganese and rare earth metal contained in the glass powder is obtained by measuring by use of an X-ray fluorescence analysis and the like. To analyze the glass powder in the dielectric paste, the dielectric paste is diluted with a solvent as required, and only the glass powder is taken out by a separator, such as a centrifugal separator. As will be described later, also in a case where a dielectric green sheet is formed by using the dielectric paste, similarly the dielectric green sheet is dissolved with a solvent, the glass powder is separated, and after that, an analysis may be performed.

The glass powder is made of a glass having a softening point of not higher than 1000° C. Therefore, the barium titanate can be sintered at temperatures of not higher than 1000° C. and simultaneous sintering of the glass-ceramic and the capacitor becomes possible.

It is preferred that the glass powder contain an alkali metal element. A glass containing an alkali metal element becomes a liquid phase at low temperatures of not higher than 1000° C., and the liquid-phase sintering of barium titanate is promoted by dispersing the barium titanate in the liquid-phase of the glass. Therefore, it becomes easy to sinter the barium titanate at low temperatures of not higher than 1000° C. Among the alkali metal elements, those having a small atomic radius such as Li and Na have a larger effect and, therefore, a dielectric layer which is dense and has high dielectric constant can be obtained by adding a small amount of such glass.

The above-described glass powder can be obtained as follows. A mixture of a network-forming oxide and a network-modifying oxide which constitute the glass, an alkali metal oxide, MnO and a rare earth oxide is melted and vitrified, and the vitrified mixture is ground by a grinding method, such as the rotary mill method and the jet mill method. Because the alkali metal element, manganese and rare earth element are introduced into the network which constitutes the glass, the temperature at which the glass softens is suppressed from becoming high.

Examples of network-forming oxides include SiO₂, B₂O₅, SO₃, P₂O₅, As₂O₅, Sb₂O₅ and the like, examples of network-modifying oxides include MgO, CaO, BaO and the like, examples of alkali metal oxides include Li₂O, Na₂O, K₂O, Cs₂O and the like, and examples of rare earth oxides include Gd₂O₃, Tb₂O₃, Dy₂O₃, Y₂O₃, Ho₂O₃, Er₂O₃, Tm₂O₃, Yb₂O₃, Lu₂O₃ and the like.

Examples of glasses containing an alkali metal element, manganese and a rare earth element obtained by the above-described method include SiO₂-M³₂O—MnO-M⁴₂O₃, SiO₂—B₂O₃-M³₂O—MnO-M⁴₂O₃ and SiO₂—B₂O₃—Al₂O₃-M³₂O—MnO-M⁴₂O₃ where M³is an alkali metal element and M⁴ is a rare earth element. Among others, SiO₂—Li₂O—MnO—Y₂O₃ is preferable from the standpoint that the dielectric paste is sintered at lower temperatures and the structure of barium titanate is made more stable.

The resin binder and solvent which are used in the dielectric paste are not especially limited so long as they permit the simultaneous sintering with a glass-ceramic green sheet. For example, those similar to a resin binder and a solvent blended to a glass-ceramic green sheet can be used. Examples of resin binders include, for example, acrylic resins (acrylic acid, methacrylic acid or homopolymers or copolymers of these esters, concretely, acrylic ester copolymers, methacrylic ester copolymers, acrylic ester-methacrylic ester copolymers and the like), and homopolymers or copolymers of polyvinyl butyral, polyvinyl alcohol, acryl-styrene resins, polyprolylene arbonate, cellulose and the like. Examples of solvents include the solvents of, for example, hydrocarbons, ethers, esters, ketones, alcohols, water and the like so that the barium titanate powder, glass powder and resin binder are dispersed and a dielectric paste of an appropriate viscosity can be obtained. Also, a dispersant may be added to ensure better dispersion.

It is preferred that a resin binder be added in amounts of 5 to 40 parts by mass or so for 100 parts by mass of the dielectric powder, which is a mixture of the barium titanate powder and the glass powder, and it is preferred that a solvent be added in amounts of 1 to 20 parts by mass or so for 100 parts by mass of the dielectric powder. As will be described later, in a case where a dielectric green sheet is formed by using the dielectric paste, it is preferred that a resin binder be added in amounts of 5 to 40 parts by mass or so for 100 parts by mass of the mixed powder and that a solvent be added in amounts of 10 to 50 parts by mass for 100 parts by mass of the mixed powder.

The dielectric paste is prepared by adding a resin binder and a solvent to the dielectric powder and kneading the mixture by use of kneading means, such as a three-roll mill. In a case where a dielectric green sheet is formed by using the dielectric paste, a resin binder and a solvent are added to the dielectric powder and mixed by use of mixing means, such as a ball mill, whereby the dielectric paste is prepared.

A capacitor-embedded glass-ceramic substrate of the present invention is fabricated as described below. First, a glass-ceramic green sheet is prepared. A solvent (an organic solvent, water and the like) and, as required, prescribed amounts of plasticizer and dispersant are added to a glass powder or a mixture of a glass powder and a ceramic powder, and resin binder, and mixed by use of mixing means, such as a ball mill, whereby a slurry is obtained. The slurry is formed into a sheet form on a supporting base, such as a PET film, by the doctor blade method, the lip coater method, the die coater method and the like, and dried, whereby a glass-ceramic green sheet is obtained.

Examples of ceramic powders include the powders of composite compounds of Al₂O₃, SiO₂ and ZrO₂, for example, and alkaline earth metal oxides, composite compounds of TiO₂ and alkaline earth metal oxides, composite compounds which contain at least one kind selected from the group consisting of Al₂O₃ and SiO₂(for example, spinel, mullite, cordierite) and the like.

Examples of glass powders include, for example, the glass powders of SiO₂—B₂O₃, SiO₂—B₂O₃—Al₂O₃, SiO₂—B₂O₃—Al₂O₃-MO (where, M indicates Ca, Sr, Mg, Ba or Zn), SiO₂—Al₂O₃-M¹O-M²O (where, M¹ and M² are the same or different and indicate Ca, Sr, Mg, Ba or Zn), SiO₂—B₂O₃—Al₂O₃-M¹O-M²O (where, M¹ and M² are the same as described above), SiO₂—B₂O₃-M³₂O (where, M³ indicates Li, Na or K), SiO₂—B₂O₃—Al₂O₃-M³₂O (where, M³ is the same as described above), SiO₂—Bi₂O₃, SiO₂—B₂O₃—Bi₂O₃, SiO₂—B₂O₃—Al₂O₃—Bi₂O₃) and the like.

Incidentally, it is needless to say that when actually using the dielectric paste, a resin binder and a solvent are added to the above-described dielectric paste composition.

As the resin binder, those which have hitherto been used in a ceramic green sheet can be used, and examples of the resin binders include, acrylic resins (acrylic acid, methacrylic acid or homopolymers or copolymers of these esters, concretely, acrylic ester copolymers, methacrylic ester copolymers, acrylic ester-methacrylic ester copolymers and the like), and homopolymers or copolymers of polyvinyl butyral, polyvinyl alcohol, acryl-styrene resins, polyprolylene arbonate, cellulose and the like.

Examples of solvents include, organic solvents of, for example, hydrocarbons, ethers, esters, ketones, alcohols, water and the like so that a glass powder, a ceramic powder and a resin binder are dispersed and a slurry of an appropriate viscosity suitable for the formation of a green sheet can be obtained.

Next, upon the surface of the obtained glass-ceramic green sheet is formed a capacitor area which comprises electrode layers and a dielectric layer formed from a dielectric paste. An electrode layer is formed on the glass-ceramic green sheet, a dielectric layer is formed on this electrode layer, and another electrode layer is formed on the dielectric layer, whereby the capacitor area is formed.

As a method of forming an electrode layer on a glass-ceramic green sheet, it is possible to use a method which involves printing a conductive paste in the shape of a prescribed pattern. The conductive paste can be prepared by adding a resin binder and a solvent to a conductor material powder and kneading the mixture by kneading means, such as a three-roll mill, and printing is performed by a printing method, such as the screen printing method and the gravure printing method.

Examples of conductor materials for the conductor material powder include, one kind or two or more kinds of metals, such as Au, Ag, Cu, Pd, Pt and W. The powder in the case of two or more kinds of metals may be a mixture of two or more kinds of metal powders or a powder containing two or more kinds of metals prepared by alloying, coating and the like. In order to suppress a decrease in the dielectric constant of the dielectric layer 1 due to the mutual diffusion of the components of an insulating substrate 3 and the dielectric layer 1, it is preferred that the conductor material powder of the dielectric paste at least in the portion which becomes an electrode layer 2 have a fine grain size of not more than 5 μm.

Also, in order to improve the adhesion between the above-described conductor material and the insulating substrate, glass is added as required. For example, the same glass as that mixed to a glass-ceramic green sheet can be used as this glass.

The resin binder and solvent used in the conductor paste are not especially limited so long as they permit simultaneous sintering with the glass-ceramic green sheet, and it is possible to use the same resin binder and solvent which are blended to the glass-ceramic green sheet.

Incidentally, interconnect layers 5 other than the electrode layer are formed simultaneously with the formation of the electrode layer in the same way as with the electrode layer. Through conductors 4 such as via-hole conductors and through-hole conductors for connecting the electrode layer and the interconnect layer or for connecting the interconnect layers together are also formed. The through conductors are formed by using means, such as burying a conductor paste in through holes by printing and press-filling. The conductor paste for through conductors is obtained by making a conductor material powder into a paste. The through holes are formed in a glass-ceramic green sheet by punching, laser processing and the like before forming the electrode layers and interconnect layers by printing. The same metal as with the above-described conductor paste can be used in the conductor paste for through conductors. However, glass is added as required in order to improve the adhesion between the through conductors and the insulating substrate. If the amount of glass decreases, gaps and voids are generated between the through conductors and the insulating substrate, thereby causing defects such as a decrease in substrate's mechanical strength. For example, the same glass as that blended to the glass-ceramic green sheet can be used as this glass.

For methods of forming the electrode layer and the interconnect layer, in addition to the above-described method by which a conductor paste is printed, a method, which involves directly forming a metal layer in the shape of a prescribed pattern on a green sheet by the plating method, the vapor deposition method and the like, or another method, which involves transferring on a green sheet a thick conductor film formed in the shape of a prescribed pattern by printing, metal foil formed in the shape of a prescribed pattern and a metal film formed in the shape of a prescribed pattern by the plating method, the vapor deposition method and the like, may be used.

For methods of forming a dielectric layer on the electrode layer formed on a glass-ceramic green sheet, a method, which involves forming a dielectric layer by printing a dielectric paste by the screen printing method, the gravure printing method and the like, or another method, which involves fabricating a dielectric green sheet by the doctor blade method, the lip coater method, the die coater method and the like by use of a dielectric paste as a slurry and stacking this green sheet on a glass-ceramic green sheet on which an electrode layer is formed, may be used.

In forming an electrode layer further on top of a formed dielectric layer, the same method as with the above-described formation of the electrode layer is adopted. In the step of fabricating a laminate of glass-ceramic green sheets, which will be describe later, it is possible to adopt a method by which an electrode layer is formed beforehand on the bottom surface of a glass-ceramic green sheet which is to be stacked on an upper part of the capacitor area and the electrode layer is stacked so as to match the position of the dielectric layer. In the case of the method which involves laminating a dielectric green sheet, it is possible to laminate a dielectric green sheet, on the top surface of which an upper electrode layer is formed beforehand, by performing positioning.

In order to further increase capacitance, the capacitor area may be formed in such a manner that multiple dielectric layers and electrode layers are alternately stacked.

Next, a laminate of glass-ceramic green sheets is fabricated by positioning and stacking multiple glass-ceramic green sheets including a glass-ceramic green sheet in which the capacitor area is formed, and then pressure-bonding the glass-ceramic green sheets. Pressure bonding is performed by applying pressures of 3.0 to 8.0 MPa or so, and heating is performed at 35 to 80° C., as required. In order to obtain the sufficient bond properties of the green sheets which are bonded together, it is possible to apply an adhesive which is prepared by mixing a solvent and a binder to the green sheets.

And lastly, a capacitor-embedded glass-ceramic multilayer substrate is fabricated by sintering the green-sheet laminate. In the sintering step, organic components are decomposed and caused to vaporize at the temperature range of 100 to 800° C. and a glass ceramic is sintered at about 800 to 1000° C. The sintering atmosphere varies depending on ceramic powders and conductor materials. In the case of Cu where the conductor materials for the electrode layer and the interconnect layer are apt to be oxidized, sintering is performed in a reducing atmosphere, such as a nitrogen atmosphere, and in a non-oxidizing atmosphere, such as a vacuum atmosphere, and steam and the like may be contained in order to effectively perform the removal of organic components.

If the green-sheet laminate having restraining green sheets further stacked on the top and bottom surfaces thereof is sintered and then the restraining green sheets are removed after sintering, it is possible to obtain a capacitor-embedded glass-ceramic multilayer substrate of higher dimensional accuracy. The restraining green sheets are green sheets which contain a difficult-to-sinter inorganic material, such as Al₂O₃, as a main component, and do not shrink during sintering. In a laminate on which this restraining green sheet is stacked, the shrinkage in the lamination plane directions (x- and y-plane directions) is suppressed by the restraining green sheets which do not shrink and shrinkage occurs only in the lamination direction (z-direction). Therefore, dimensional variations associated with shrinkage during sintering are suppressed.

It is preferred that the restraining green sheet contain a glass component having a softening point which is not more than the sintering temperature in addition to the difficult-to-sinter inorganic component, for example, the same glass as the glass contained in the green sheet. This is because this glass softens during sintering and combines with the green sheet, with the result that the bond between the green sheet and the restraining sheet becomes strong and that a more positive restraining force is obtained. When the amount of glass at this time is 0.5 to 15% by mass for the inorganic component which is a total of the difficult-to-sinter inorganic component and the glass components, the restraining force increases and the sintering shrinkage of the restraining green sheet is limited to not more than 0.5%.

Examples of methods of removing the restraining green sheet include, for example, polishing, water jet, chemical blasting, sand blasting, wet blasting (a method which involves pneumatically emitting abrasive grains and water) and the like.

Incidentally, the component ratio of the barium titanate and glass contained in the dielectric layer of a fabricated capacitor-embedded glass-ceramic multilayer substrate and the component ratio of the manganese and rare earth metal contained in the glass are little different from those of the dielectric paste and can be analyzed also from the capacitor-embedded glass-ceramic multilayer substrate.

Therefore, a capacitor-embedded glass-ceramic multilayer substrate fabricated by sintering the dielectric paste of the present invention and the glass-ceramic green sheet has a capacitor area which comprises a dielectric layer which consists essentially of 70.0 to 99.6 parts by mass of barium titanate and 0.4 to 30.0 parts by mass of a glass containing manganese and a rare earth element and having a softening point of not higher than 1000° C., and electrodes.

The composition of the dielectric layer is obtained by measuring, after cutting the capacitor-embedded glass-ceramic multilayer substrate, the composition ratio of the dielectric layer appearing in the section by atomic absorption analysis, emission spectrometry and the like. As a concrete method, the substrate is first cut and the dielectric layer 1 formed in the interior is brought into a condition permitting observation from the outside, for example, by polishing the section. After that, a range of the dielectric substance portion of about 10 μm or so is irradiated with laser rays by use of the laser abrasion system (LSX-200 made by CETAC Technologies), whereby the dielectric component is vaporized. By analyzing the vaporized dielectric component by ICP emission spectrometry, the composition ratio in oxides in each element is measured. Next, a combined portion of the BaO component and TiO₂ component, which corresponds to the composition ratio of barium titanate, and another portion, which corresponds to the glass composition ratio, are calculated from the obtained composition ratio. The calculated glass composition ratio is regarded as 100 parts by mass, and the composition ratio of the MnO and rare earth oxide contained in the glass is calculated.

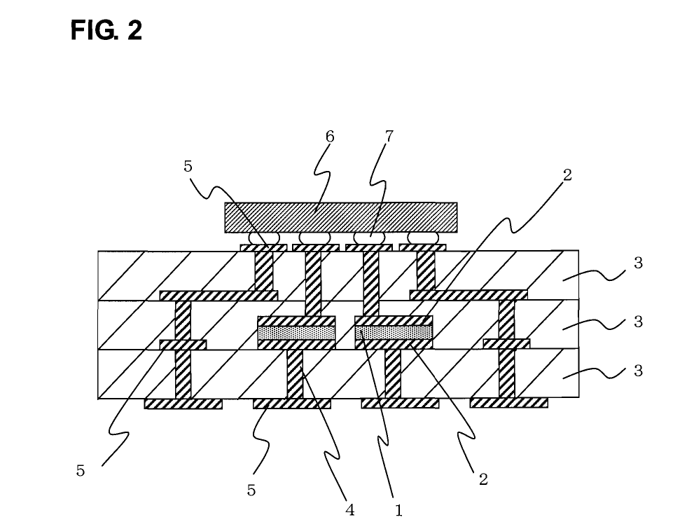

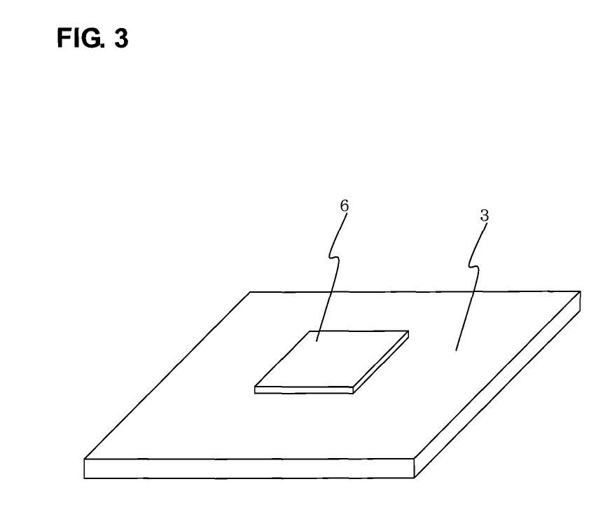

FIGS. 2 and 3 are a sectional view and a perspective view, respectively, which show an example of an embodiment of an electronic component of the present invention.

The electronic component of the present invention includes the above-mentioned capacitor-embedded glass-ceramic multilayer substrate, an electronic device 6 placed thereon, and an interconnected line which is formed on an insulating layer 3 and connects an electrode of the electronic device 6 and an electrode layer 2 of the capacitor. The interconnected line includes a through conductor 4 and an interconnect layer 5. The electronic device 6 is connected to the interconnect layer 5 through an electric connector 7, such as a solder.

### Embodiments

Embodiments of a dielectric paste and a capacitor-embedded glass-ceramic multilayer substrate of the present invention will be described in detail. A sectional view of a capacitor-embedded glass-ceramic multilayer substrate fabricated as a sample is shown in FIG. 1. The capacitor-embedded glass-ceramic multilayer substrate shown in FIG. 1 was fabricated as described below.

First, 60 parts by mass of an SiO₂—CaO—MgO glass powder as glass and 40 parts by mass of Al₂O₃ powder as a ceramic powder were mixed, 12 parts by mass of acrylic resin and 6 parts by mass of a phthalic acid plasticizer as resin binders and 30 parts by mass of toluene as a solvent for 100 parts by mass of this mixed powder were added and mixed to generate a slurry by the ball mill method. A glass-ceramic green sheet which becomes an insulating layer 3 having a thickness of 250 μm was formed from this slurry by the doctor blade method.

Next, a conductor paste was applied onto a glass-ceramic green sheet, which becomes the insulating layer 3 that is a middle layer, by screen printing, and an electrode layer 2 which is 1.3 mm in length, 1.3 mm in width and 12 μm in thickness was formed by drying the conductor paste by a warm wind at 80° C. The conductor paste was prepared by mixing 98.0 parts by mass of a Cu powder and 2.0 parts by mass of an SiO₂—B₂O₃ glass powder, adding 10.9 parts by mass of an acrylic resin as a resin binder and 1.5 parts by mass of terpineol as a solvent for 100 parts by mass of this mixed powder, and performing kneading by use of the stirring deaerator SNB-350 (made by IKS).

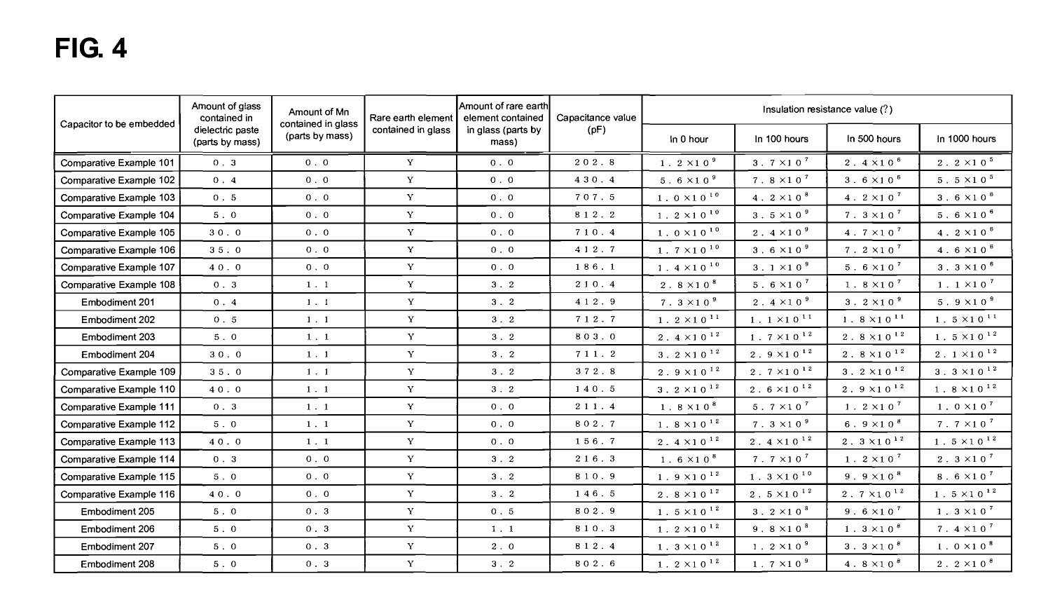

Next, a dielectric paste was applied onto the electrode 2 by the screen printing method and dried by a warm wind at 80° C., whereby a dielectric layer which is 1.7 mm in length, 1.7 mm in width and 27 μm in thickness was formed. The dielectric paste was prepared by adding 30.0 parts by mass of an acrylic resin as a resin binder, 3.0 parts by mass of terpineol as a solvent and 3.0 parts by mass of a non-ionic dispersant to 100 parts by mass of a mixed powder, which consists of a barium titanate powder and an SiO₂—Li₂O—MnO-M₂O₃ (M indicates a rare earth element), and the mixture was thoroughly kneaded by a three-roll mill after thorough mixing by use of the stirring deaerator. The ratio of the barium titanate powder and the glass powder, the amount of manganese (Mn) contained in the glass, and the kind and amount of the rare earth metal contained in the glass are shown in FIG. 4.

And the conductor paste was applied to the dielectric layer 1 and dried by a warm wind at 80° C., and a capacitor area was formed by forming an upper electrode pattern 2 which is 1.3 mm in length, 1.3 mm in width and 12 μm in thickness.

A through hole 0.2 mm in diameter was formed by punching by use of a die in bottom-layer and top-layer glass-ceramic green sheets which become the insulating film 3, and a conductor paste for through conductor was filled in the interior of the through hole by screen printing, whereby a through conductor 4 was formed. The conductor paste for through conductor was prepared by mixing 92.0 parts by mass of a Cu powder and 8.0 parts by mass of an SiO₂—B₂O₃ glass powder, adding 12.0 parts by mass of an acrylic resin as a resin binder, 1.0 parts by mass of terpineol as a solvent to 100 parts by mass of this mixed powder and kneading the mixture by use of a stirring deaerator SNB-350 (made by IKS). A conductor paste was applied to the part where the through conductor 4 is exposed on the glass-ceramic green sheet and dried by a warm wind at 80° C., whereby the interconnect layer 5 was formed.

Next, top-layer, middle-layer and bottom-layer glass-ceramic green sheets which become the insulating film 3 were stacked and vacuum pressed at a pressure of 5.6 Pa and a temperature of 55° C., whereby a laminate of glass-ceramic green sheets was fabricated.

Lastly, the laminate of glass-ceramic green sheets was subjected to debinding at 700° C. for an hour in an N₂ atmosphere which had been passed through warm water at 60° C., and subsequently sintered at 900° C. for 40 minutes in an N₂ atmosphere, whereby a capacitor-embedded glass-ceramic multilayer substrate was fabricated.

For the capacitor-embedded glass-ceramic multilayer substrate thus fabricated, the capacitance value of the embedded capacitor and the insulating properties against heating and voltage application were evaluated.

With the probe of an impedance measuring device (type “4294A precision impedance analyzer”, measuring accuracy ±0.08%, made by Agilent Technologies) put to the interconnect layer 5, the capacitance measurement was made with a measurement frequency of 1 MHz and at a measurement temperature of 25° C.

For the evaluation of the insulating properties against heating and voltage application, heating at 125° C. and application of a voltage of 32 V were performed, and insulation resistance values in 0 hour, 100 hours and 1000 hours after heating and voltage application were measured. The measurement of insulation resistance values was performed at a measurement voltage of 16 V and a measurement temperature of 25° C. by use of the digital supermeghohmmeter DSM-8103 (made by TOA), and insulation resistance values in 1 minute after voltage application was measured.

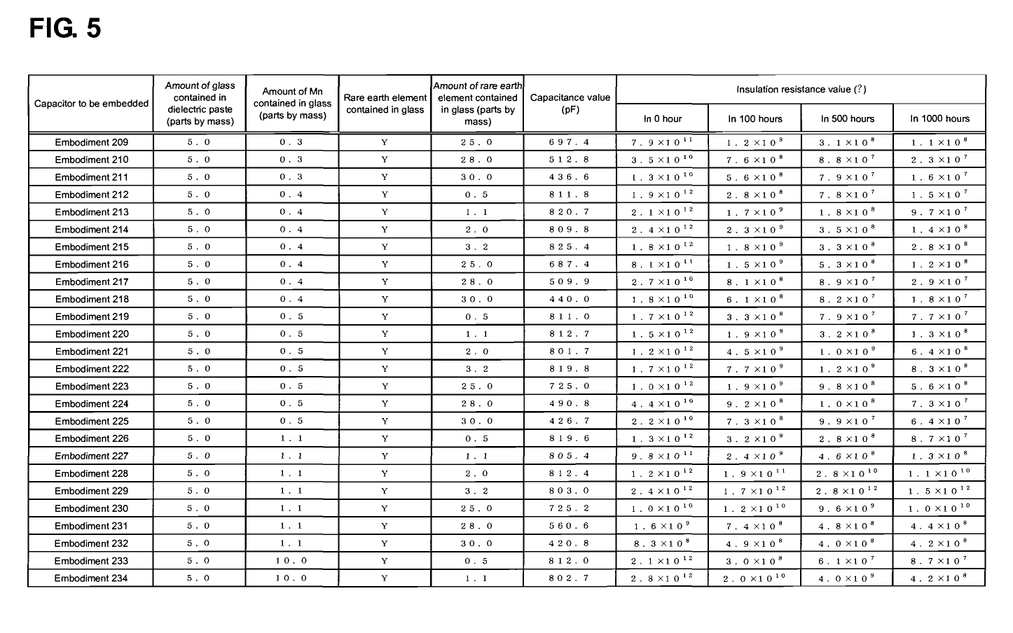

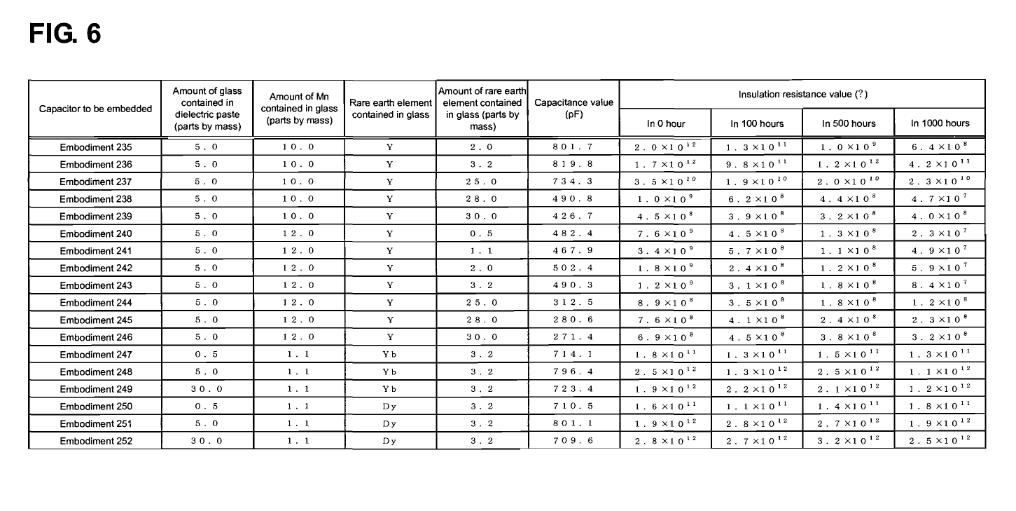

The measurement results of the capacitance value and insulation resistance value of the embedded capacitor are shown in FIGS. 4 to 6.

As one of the guidelines in which desired capacitance values are obtained, capacitance values of not less than 400 pF, more preferably not less than 700 pF were regarded as rough standards. As a guideline for the evaluation of insulation resistance reliability, standards concerning the insulation resistance value of multilayered ceramic capacitors were referred to as a rough standard, and if the insulation resistance value in 1000 hours after heating at 125° C. and application of a voltage of 32 V is not less than 1.0×10⁷ Ω, then the embedded capacitor in question was considered to be applicable at a working voltage of 16 V. In a case where the insulation resistance value in 1000 hours is not less than 5.0×10⁸ Ω, the capacitor in question was considered to have sufficiently high reliability at a working voltage of 16 V. Accordingly, in a case where the capacitance is not less than 400 pF and the insulation resistance value in 1000 hours is not less than 1.0×10⁷ Ω, the capacitor in question is an excellent one in which the object of the present invention is capable of being achieved. In particular, in a case where the capacitance is not less than 700 pF and the insulation resistance value in 1000 hours is not less than 5.0×10⁸ Ω, the capacitor in question is considered to be a capacitor having high dielectric constant and excellent insulating properties.

From comparisons between Embodiments 201 to 252 and Comparative Examples 101 to 116, it became apparent that the capacitors of Embodiments 201 to 252 fabricated by using a barium titanate and a glass powder containing Y, which is a rare earth element, are capacitors having sufficiently high capacitance and sufficiently high reliability. Particularly, in Embodiments 202 to 204, 221 to 223, 228 to 230, 235 to 237, and 247 to 252, in which the amount of glass contained in the dielectric paste is 0.4 to 30.0 parts by mass, the amount of manganese is 0.5 to 10.0 parts by mass for 100 parts by mass of the above-described glass and the amount of the rare earth metal is 2.0 to 25.0 parts by mass for 100 parts by mass of the above-described glass, the capacitance was not less than 700 pF and the insulation resistance values in 1000 hours or so was not less than 5.0×10⁸ Ω, and it became apparent that these capacitors have high dielectric constant and excellent in the insulating properties.

In contrast, in the capacitors of Comparative Examples 101 to 116 which are outside the scope of the present invention, capacitance values were low or decreases in the insulation resistance value were observed.

The present invention can be carried out in other various forms without departing from the spirit or principal features thereof. Therefore, the above-described embodiments are illustrative only in all respects and the scope of the present invention is described in the claims and is not limited by the body of the specification in the least. Furthermore, modifications and changes belonging to the claims are all within the scope of the present invention.

What is claimed is:

1. A dielectric paste, comprising 70.0 to 99.6 parts by mass of a barium titanate powder and 0.4 to 30.0 parts by mass of a glass powder made of a glass containing manganese and a rare earth element and having a softening point of not higher than 1000° C.

2. The dielectric paste according to claim 1, wherein the manganese is contained in amounts of 0.5 to 10.0 parts by mass for 100 parts by mass of the glass and the rare earth element is contained in amounts of 2.0 to 25.0 parts by mass for 100 parts by mass of the glass.

3. A capacitor-embedded glass-ceramic multilayer substrate comprising:
a laminated body in which multiple insulating layers made of a glass ceramic are stacked;
an interconnect layer; and
a capacitor area including a dielectric layer, which comprising 70.0 to 99.6 parts by mass of barium titanate and 0.4 to 30.0 parts by mass of a glass containing manganese and a rare earth element and has a softening point of not higher than 1000° C., and electrodes.

4. The capacitor-embedded glass-ceramic multilayer substrate according to claim 3, wherein the manganese is contained in amounts of 0.5 to 10.0 parts by mass for 100 parts by mass of the glass and the rare earth element is contained in amounts of 2.0 to 25.0 parts by mass for 100 parts by mass of the glass.

5. A electronic component, comprising:
the capacitor-embedded glass-ceramic multilayer substrate according to claim 3;
an electronic device which is placed on the capacitor-embedded glass-ceramic multilayer substrate; and
an interconnected line which is formed on an insulating layer and which connects an electrode of the electronic device and an electrode of the capacitor.

6. A method of manufacturing a glass-ceramic multilayer substrate, comprising the steps of:
preparing a glass-ceramic green sheet;
forming, on a surface of the glass-ceramic green sheet, a capacitor area including electrode layers and a dielectric layer formed from the dielectric paste according to claim 1;
fabricating a laminate by stacking the glass-ceramic green sheets; and
sintering the laminate.
